(19) United States
(12) Patent Application Publication
(10) Pub. No.: US 2006/0191388 A1
(43) Pub. Date: Aug. 31, 2006

(54) Web processing device

(75) Inventor: Soichiro Higashi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/358,104

(22) Filed: Feb. 22, 2006

(30) Foreign Application Priority Data
Feb. 25, 2005 (JP) 2005-51566

(51) Int. Cl. B26D 1/00; B26D 3/00

(52) U.S. Cl. 83/13; 83/44; 83/343

(57) ABSTRACT

The present invention provides a web processing device comprising: a coating unit which coats a long strip of web by using a bar having in an axial direction at least two spiral grooved portions differing in the spiraling direction of the spiral groove; and a cutting unit which cuts the coated web in the lengthwise direction in a coating position along the boundary between the two spiral grooved portions. By using the bar having two spiral grooved portions, any foreign matter can be quickly shoved out to prevent it from inviting a seam flaw and, moreover, the adverse effect of any seam flaw occurring along the boundary between the two spiral grooved portions can be eliminated, with the result that high-quality processed webs can be manufactured at a high yield.

### BACKGROUND OF THE INVENTION

1. Field of the Invention

The present invention relates to a web processing device, and more particularly to a web processing device for manufacturing photosensitive films, such as photographic films, or magnetic tapes including computer backup tapes.

2. Description of the Related Art

Bar coaters are known as a device for applying a coating liquid to a continuously running long strip of web. A bar coater forms a coat layer over a surface of a continuously running web by discharging a coating liquid onto the part of the web upstream from the bar while keeping a columnar rod known as a bar in contact with the under face of the web. The bar is used in the same direction or the direction reverse to the continuous running of the web or in a stationary state. Known types of bars include a flat bar whose outer circumferential face is flat, a wire bar wound with a wire and a roll forming bar in whose outer circumferential face a spiral groove is cut.

A bar coater using a roll forming bar, out of these different bars, is subject to a phenomenon in which any foreign matter such as burrs or chips from the web having reached the bar moves in the widthwise direction along the spiral groove, with the result that foreign matters positioned at the downstream end in the moving direction are shoved outward and automatically removed. At the same time, as foreign matters positioned at the upstream end in the moving direction move toward the middle part of the web, they may invite a seam flaw. In recent years, as the width of the web subjected to the coating process is greater than before, foreign matters on the web are more likely to fail to reach the edge of the web and thereby invite a seam flaw.

Various shapes are proposed for roll forming bars conventionally. For instance, Japanese Utility Model Application Laid-Open No. 1994-29667 disclosed a bar having two spiral grooves which are symmetric between right and left. Since this bar moves foreign matters on the web rightward and leftward, they can be quickly shoved out of the edges of the web.

### SUMMARY OF THE INVENTION

However, it has been found that the use of a bar having two spiral grooves would give rise to seams and other flaws in the central position of the bar (namely on the boundary between the two spiral grooves), and this makes it impossible for the bar to be used as a satisfactory product. Thus, the present inventor tested a bar with two spiral grooves in various ways, and found that seam flaws both of thin coating and thick coating occurred on the boundary between the two spiral grooves, and that these seam flaws could hardly be eliminated even if the coating conditions were altered. Thus, even if seam flaws are controlled by using a bar having two spiral grooves, new seam flaws will occur, making it impossible for the bar to be used as a satisfactory product. Accordingly, it has been impossible to use a bar having two spiral grooves for practical purposes.

An object of the present invention, attempted in view of these circumstances, is to provide a web processing device which can suppress seam flaws due to foreign matters by using a bar having two spiral grooves differing in spiraling direction and can eliminate the effects of seam flaws ensuing from the boundary between the two spiral grooves.

In order to achieve the object stated above, according to a first aspect of the invention, a web processing device comprises a coating unit which coats a long strip of web by using a bar having in the axial direction at least two spiral grooved portions differing in the spiraling direction of the spiral groove, and a cutting unit which cuts the coated web in the lengthwise direction in a coating position along the boundary between the two spiral grooved portions.

According to the first aspect of the invention, by combining a coating unit which performs coating by using a bar having at least two spiral grooved portions and a cutting unit which cuts a wider web into narrower strips, the cutting is accomplished along the boundary between the two grooved portions. As this causes the parts coated along the boundary between the grooved portions to be discarded as unnecessary ears of the cut web strips, they do not remain in the finished product and therefore have no adverse effect. Therefore according to the first aspect of the invention, by using the bar having two spiral grooved portions, any foreign matter can be quickly shoved out to prevent it from inviting a seam flaw and, moreover, the adverse effect of any seam flaw occurring along the boundary between the two spiral grooved portions can be eliminated, with the result that high-quality processed webs can be manufactured at a high yield.

According to a second aspect of the invention, the coating unit according to the first aspect of the invention is provided with a coating position adjusting device which adjusts the coating position in the widthwise direction of the web by shifting in the bar or the web relative to the widthwise direction of the web. Therefore, according to the second aspect of the invention, it is possible to adjust the coating position along the boundary between the spiral grooved portions in the widthwise direction of the web.

According to a third aspect of the invention, the cutting unit according to the first or second aspect of the invention is provided with a cutting position adjusting device which adjusts the cutting position in the widthwise direction of the web according to the coating position in the widthwise direction of the web in the coating unit. Therefore, according to the third aspect of the invention, it is possible to cut the web according to the coating position and securely along the boundary between the two spirally grooved portions.

According to a fourth aspect of the invention, the boundary between the spiral grooved portions according to any of the first through third aspects of the invention is so formed as not to let the spiral grooves overlap each other. The use of a bar having such a shape allows no foreign matters to be caught on the boundary because there is no spiral groove, and therefore can prevent seam flaws due to foreign matters from occurring on the boundary.

According to a fifth aspect of the invention, the boundary between the spiral grooved portions according to any of the first through third aspects of the invention is so formed as to overlap each other on the boundary between the grooved portions and the length of the overlapping part is kept not less than 10 mm but not more than 30 mm in the axial direction of the bar. The use of a bar having such a shape, as it causes the coating liquid to be held in both spiral grooves, seam flaws due to thin coating can be restrained along the boundary.

According to a sixth aspect of the invention, the bar according to any of the first through third aspects of the invention is formed by joining together rods at the end face in which spiral grooves differing in spiraling direction are cut. The use of a bar having such a configuration causes any foreign matter to be shoved out instead of staying on the boundary between the grooved portions. Accordingly, seam flaws due to foreign matters can be prevented all over the web.

The web processing device according to the present invention, as it performs coating by using a bar having at least two spiral grooved portions and a cutting unit which cuts the web in the coating position on the boundary between the grooved portions, the rate of seam flaw occurrence due to foreign matters can be restrained, and the adverse effect of any seam flaw occurring along the boundary can be eliminated, with the result that high-quality processed webs can be manufactured at a high yield.

### BRIEF DESCRIPTION OF THE DRAWINGS

FIG. 1 is a schematic showing the configuration of a web processing device according to the invention;

FIG. 2 shows a front view of a bar in a coating unit;

FIG. 3 shows area P in FIG. 2 on an enlarged scale;

FIG. 4 is a perspective view schematically showing the configuration of the coating unit and a cutting unit;

FIG. 5 illustrates the action of the web processing device;

FIG. 6 shows a bar whose boundary of spiral grooves which differs in configuration from that shown in FIG. 3;

FIG. 7 shows another bar whose boundary of spiral grooves which differs in configuration from that shown in FIG. 3;

FIG. 8 shows a front view of a bar in a second preferred embodiment of the invention; and

FIG. 9 shows a front view of a bar which differs in configuration from that shown in FIG. 8.

### DETAILED DESCRIPTION OF THE PREFERRED EMBODIMENTS

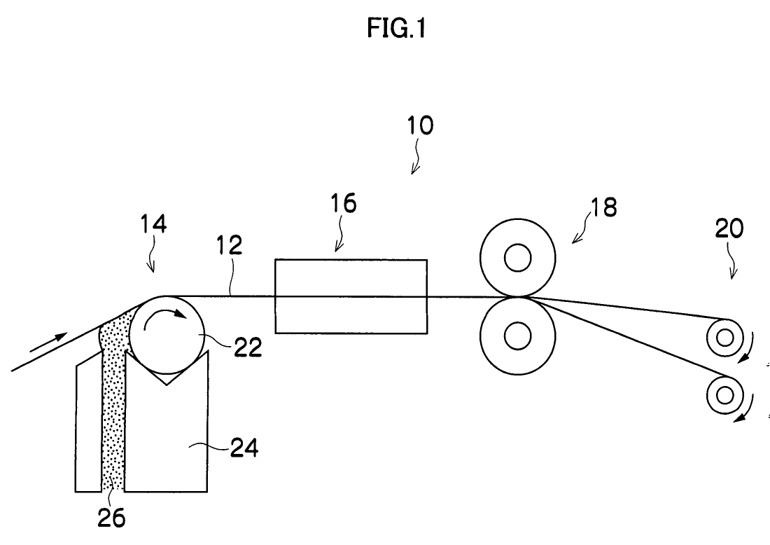

Web processing devices, which are preferred embodiments of the present invention will be described below with reference to the accompanying drawings. FIG. 1 is a schematic showing the configuration of a web processing device according to the invention.

As shown in FIG. 1, a web processing device 10 is mainly configured of a coating unit 14, a drying unit 16, a cutting unit 18 and a winding unit 20, wherein a long strip of web 12 runs to pass the coating unit 14, the drying unit 16, the cutting unit 18 and the winding unit 20 in that sequence. Therefore, the long strip of web 12 is first coated on its under face with a coating liquid by the coating unit 14, then undergoes drying of the coating liquid by the drying unit 16 and, after being cut in the lengthwise direction by the cutting unit 18, is wound into a roll by the winding unit 20. The individual processing units will now be described below.

The coating unit 14 comprises a supporting member 24 having a V-shaped groove 24A at the top and a bar 22 supported by the groove 24A of the supporting member 24. The web 12 is wound around a guide roller and other elements not shown, and a running path is so formed that the web 12 be brought into contact with the bar 22 at a prescribed lap angle. A discharge path 26 for the coating liquid is formed upstream from the bar 22 in the running direction of this web 12, and the coating liquid is discharged from this discharge path 26 toward the under face of the web 12. The coating liquid having stuck to the under face of the web 12 is measured by the bar 22, and a prescribed quantity of the coating liquid is applied to the under face of the web 12.

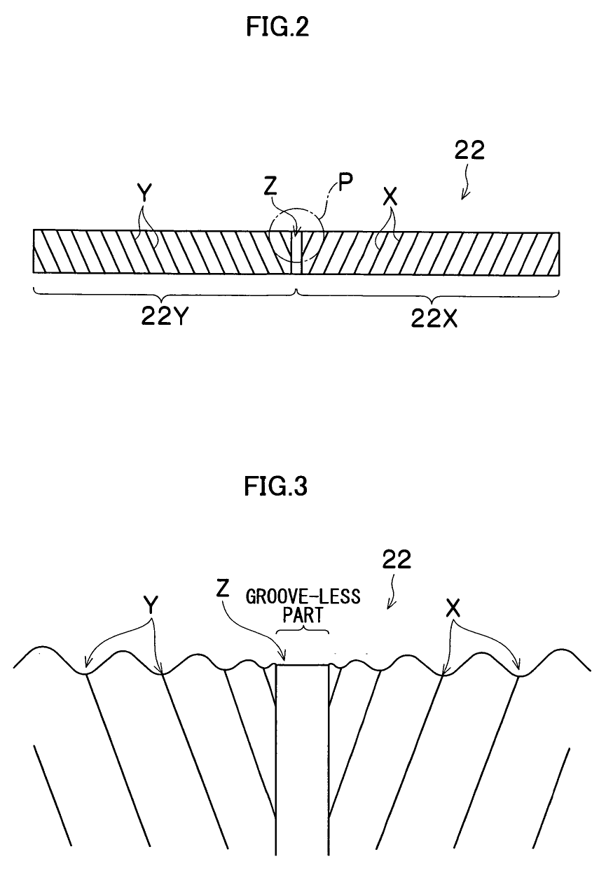

FIG. 2 shows a front view of the bar 22. As shown in FIG. 2, in the bar 22, spiral grooves X and Y differing in spiraling direction are formed separately on the right and left parts of the bar 22. Thus a grooved portion 22X, in which the spiral groove X is formed, is disposed in the right half of the bar 22, and a grooved portion 22Y in which the spiral groove Y, differing from the spiral groove X in spiraling direction, is formed is disposed in the left half of the bar 22.

The bar 22 of this kind can be fabricated by subjecting a columnar core bar, after being ground, to roll forming. Roll forming is accomplished by rotating, after removing convexes on the surface of the bar by grinding it with a die having no groove, either the core bar or a die having a groove in the circumferential direction and shifting the core bar in the axial direction, while pressing this die against the outer circumferential face of the core bar. The two different the spiral grooves X and Y differing in spiraling direction are formed by performing this roll forming in two separate rounds, one applied to the right end to the center of the core bar and the other to the left end to the center of the core bar, and forming grooves in mutually reverse direction in those two rounds of roll forming. In this way, the grooved portion 22X having the spiral groove X and the grooved portion 22Y having the spiral groove Y are formed in the bar 22. As the material of the core bar, a metal whose surface hardness is sufficient for roll forming, such as SUS 304 or SUS 316, is used. There is no particular restriction regarding the shapes of the spiral groove X and Y, but they may have shapes of alternately repeated concaves and convexes each having an arciform section as shown in FIG. 3. Alternatively, concaves having an arciform section may as well be solely repeated, or convexes having an arciform section may as well be solely repeated.

It is preferable for the core bar roll-formed as described above to be plated after its surface is completely cleared of adhesions by electrolytic defatting. A preferable way of plating is the formation of a coat of a hard material (for instance hard chromium plating, amorphous chromium plating, or the formatting of a ceramic coat, a diamond coat or a hard resin coat). The plating should preferably followed by buffing to remove pits and other flaws.

FIG. 3 shows area P in FIG. 2 on an enlarged scale. As shown in FIG. 3, the spiral groove X on the right side and the spiral groove Y on the left side are so formed as not to overlap each other in the central part. Thus, a flat part having neither the spiral groove X nor Y is disposed along the boundary Z between the grooved portion 22X and the grooved portion 22Y.

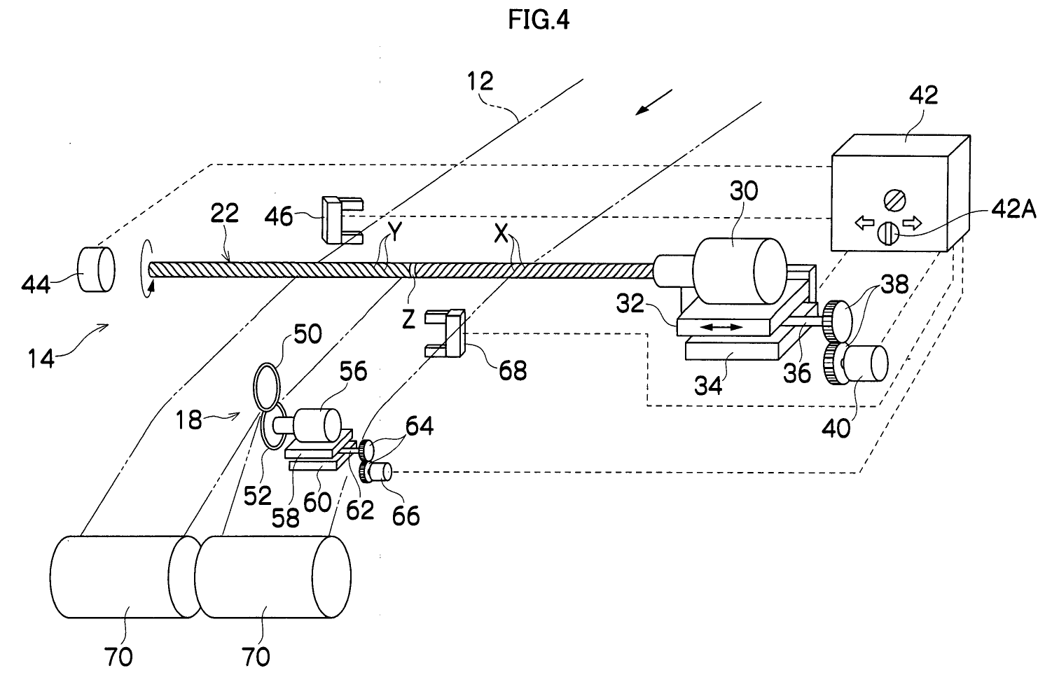

FIG. 4 is a perspective view schematically showing the configuration of the coating unit 14 and the cutting unit 18 which are characteristic elements of the present invention. As shown in FIG. 4, the right end of the bar 22 of the coating unit 14 is linked to a rotating motor 30, and by driving this rotating motor 30, the bar 22 is turned in the running direction of the web 12. The rotating motor 30 is mounted on a slide plate 32, and this slide plate 32 is supported by a base 34 to be slidable in the widthwise direction of the bar 22 (namely the widthwise direction of the web). Further, a feed screw 36 is screwed into the slide plate 32, and this feed screw 36 is turned by a positioning motor 40 via gears 38 and 38. Therefore, by driving the positioning motor 40 to turn the feed screw 36, the slide plate 32 and the rotating motor 30 slide to enable the position of the bar 22 to be adjusted in the widthwise direction. To add, the positioning motor 40 is connected to a controller 42, and its driving is controlled by this controller 42. The controller 42 is provided with an inching lever 42A, and the positioning motor 40 is driven by manipulating this inching lever 42A right and left to adjust the position of the bar 22 in the widthwise direction.

A position detecting sensor 44 for detecting the position of the bar 22 in the widthwise direction is disposed to the left of the bar 22. The position detecting sensor 44 is connected to the controller 42, which subjects the position of the bar 22 to feedback control on the basis of the detection value of this position detecting sensor 44.

An edge position detecting sensor 46 for detecting the edge position of the web 12 is disposed on the upstream side of the bar 22 relative to the running direction of the web 12. On the basis of the detection value of this edge position detecting sensor 46, the controller 42 adjusts the position of the bar 22 in the widthwise direction, and arranges the boundary Z between the grooved portions 22X and 22Y in the central position of the web 12 in the widthwise direction.

On the other hand, the cutting unit 18 is provided with a rotary cutter consisting of an upper cutting edge 50 and a lower cutting edge 52, both disk-shaped. The upper cutting edge 50 is rotatably supported, while the lower cutting edge 52 is linked to a rotating motor 56. By driving this rotating motor 56, the lower cutting edge 52 is turned in tune with the running web 12. Thus, the lower cutting edge 52 is turned in the running direction of the web 12 at the same speed as the web 12. The web 12 is so arranged as to pass between the upper cutting edge 50 and the lower cutting edge 52, which cut the web 12 in the lengthwise direction. A slide plate 58 is fitted to the rotating motor 56, and this slide plate 58 is supported by a base 60 to be slidable in the widthwise direction of the web 12. A feed screw 62 is screwed into the slide plate 58, and this feed screw 62 is connected to a positioning motor 66 via gears 64 and 64. Therefore, by driving the positioning motor 66, the feed screw 62 is turned to shift the slide plate 58 the rotating motor 56 in the widthwise direction. As the upper cutting edge 50 and the lower cutting edge 52 are thereby shifted in the widthwise direction of the web 12, the cutting position of the web 12 can be adjusted in the widthwise direction of the web 12.

An edge position detecting sensor 68 for detecting the edge position of the web 12 is disposed on the upstream side of the upper cutting edge 50 and the lower cutting edge 52 relative to the running direction of the web 12. By adjusting the positions of the upper cutting edge 50 and the lower cutting edge 52 in the widthwise direction on the basis of the position detected by this edge position detecting sensor 68, the controller 42 so exercises control as to cut the web 12 in the central position in the widthwise direction. Thus, the control is so effected as to cut it in the coated part along the boundary Z between the grooved portions 22X and 22Y.

The cut webs 12 and 12, which are narrowed in width, are wound by winding shafts 70 and 70 of the winding unit 20, and the narrower webs 12 and 12 wound by the winding shafts 70 and 70 are cleared of their ends in the widthwise direction (ears) by equipment for post-treatment (not shown) to be finished into commercially marketable products.

The operations of the web processing device 10 configured as described above will now be described.

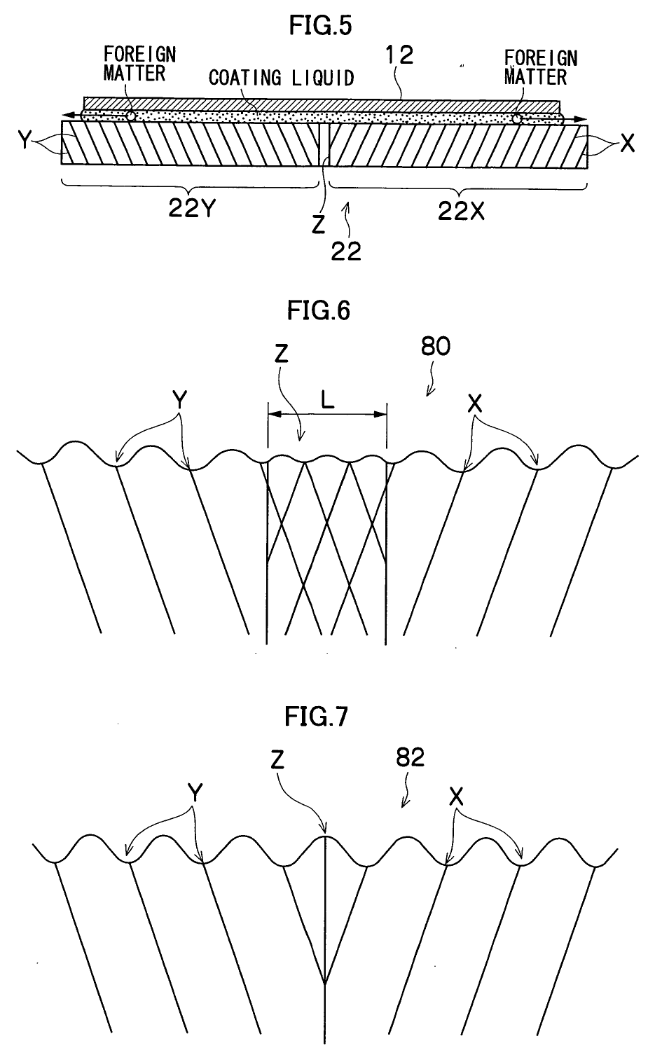

Foreign matters such as burrs (for instance peculiar return scraps of the cut portion resulting from cutting with a knife cutter in a high temperature ambience) or chips may be found on the ends of the webs 12. These foreign matters, when they reach the coating unit 14, are scraped off by the bar 22. The foreign matters are then moved, together with the coating liquid, in the widthwise direction by the spiral motions of the spiral grooves X and Y of the bar 22 as shown in FIG. 5. Thus in the right half of the bar 22, they are moved rightward by the action of the spiral groove X while in the left half of the bar 22, they are moved leftward by the action of the spiral groove Y. Therefore, since the foreign matters are promptly shoved out without entering the central portion of the bar 22, any seam flaw that could be caused by foreign matters can be prevented.

As described above, since the two spiral grooves X and Y differing in spiraling direction are formed in the bar 22 in this embodiment of the invention, foreign matters can be positively removed by the bar 22 and therefore any seam flaw that could be caused by foreign matters can be prevented.

Incidentally, tests conducted by the present inventor have revealed that the use the bar 22 having the two spiral grooves X and Y as described above invites seam flaws due to thin coating could occur along the boundary Z between the spiral grooves X and Y. Therefore, for this embodiment of the invention, control is so exercised as to bring the center of the bar 22 (i.e. the boundary Z between the grooved portions 22X and 22Y) to the central position of the web 12 in the widthwise direction in the coating unit 14 and to have the web 12 cut in its central position in the widthwise direction by the cutting unit 18. Namely, the coating position on the boundary Z and the position of cutting by the cutting unit 18 are made identical in the widthwise direction of the web 12. Therefore, on the cut webs 12 narrowed in width, any seam flaw that would arise as described would be on edges in the widthwise direction. These edges are removed as unnecessary ears in post-treatment. Therefore, this embodiment, since it is free from seam flaws in the central parts of the narrowed webs 12, which are the finished products, can provide commercially marketable precuts of high quality.

Further in this embodiment of the invention, as the bar 22 is fabricated by roll forming, the surface shape (i.e. the spiral grooves X and Y) can be formed with high accuracy. Also, as the bar 22 is made of a plated core bar, the surface hardness is enhanced to protect the surface of the bar 22 from damages and thereby to extend the useful life of the bar 22. Moreover, as the roll-formed surface of the bar 22 is plated, the surface is difficult to be hardly smeared, and any seam flaw that could be caused by the adhesion of foreign matters can be thereby prevented.

To add, though the coating position is adjusted by shifting the bar 22 in the widthwise direction in the embodiment described above, it can as well be adjusted by shifting the web 12 in the widthwise direction. Similarly, though the cutting position is adjusted by shifting the upper cutting edge 50 and the lower cutting edge 52 in the widthwise direction in the embodiment, the cutting position may as well be adjusted by shifting the web 12 in the widthwise direction. The shifting of the web 12 could be accomplished by shifting or inclining the guide roller (path roller).

Although the coating position and the cutting position are adjusted independent of each other in the embodiment described above, it is sufficient to align the boundary Z between the grooved portions 22X and 22Y with the cutting position, and therefore either the coating position or the cutting position may be fixed. If for instance the coating position is fixed, the coating position can be detected and the cutting position can be adjusted according to that coating position.

Further, though the spiral grooves X and Y are prevented from overlapping each other along the boundary Z between the grooved portions 22X and 22Y in the embodiment described above, the configuration of the boundary Z is not restricted to this. For instance, a bar 80 shown in FIG. 6 is so configured that the spiral grooves X and Y partially overlap each other in the central part of the bar 80. In this case, the incomplete peak parts of the spiral grooves X and Y (namely the parts where the groove depth is shallower than is specified) are laid one over the other, and the length L of the overlapping parts is kept not less than 10 mm but not more than 30 mm. The use of a bar 80 formed in this way, since the two incomplete peak parts overlap each for a length of at least 10 mm along the boundary Z, the incomplete peak parts can hold the coating liquid to restrain the occurrence of seam flaws due to thin coating more effectively than where these parts are flat. The length of the incomplete peak parts not more than 30 mm serves to prevent foreign matters from being held there to invite seam occurrence.

A bar 82 shown in FIG. 7 is formed by joining a rod in which a spiral groove X is cut and another rod in which a spiral groove Y is cut are joined at their respective end faces. Such a bar 82 has no incomplete groove in the boundary Z between the grooved portions 22X and 22Y, and can prevent seam flaws due to thin coating from occurring. Although the bar 82 might give rise to a seam flaw (level gap) due to thick coating along the boundary Z between the grooved portions 22X and 22Y, the cutting along the boundary Z between the spiral grooves X and Y in this embodiment can remove any such seam flaw.

Next, a second preferred embodiment of the invention will be described. In this second preferred embodiment, the wider web 12 is cut in two positions in the widthwise direction in the cutting unit 18 shown in FIG. 1.

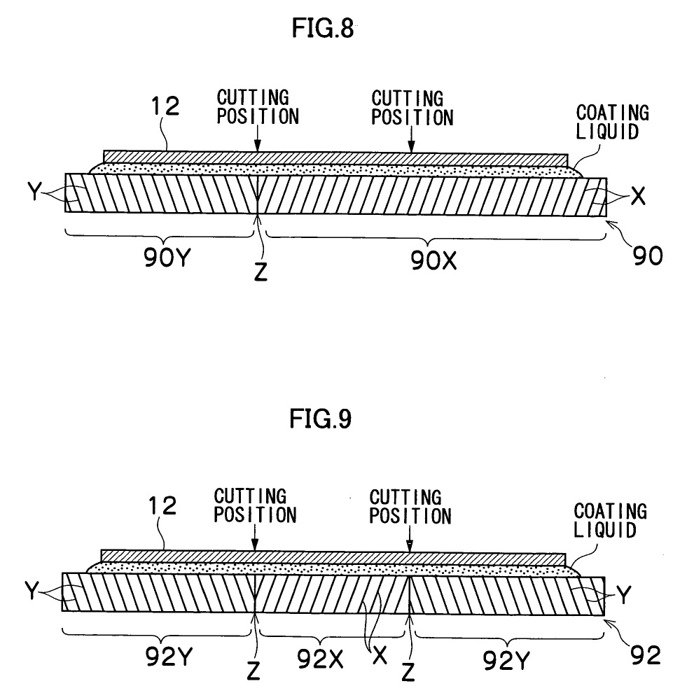

As shown in FIG. 8, a bar 90 in the second embodiment has a spiral groove X formed in an approximately ⅔ part to the right and a spiral groove Y an approximately ⅓ part to the left. Thus, a grooved portion 90X in which the spiral groove X is formed is disposed in an approximately ⅔ part of the bar 90 to the right and a grooved portion 90Y in which the spiral groove Y is disposed in an approximately ⅓ part of the bar 90 to the left. The cutting unit 18 (not shown) in the second embodiment cuts the web not only along the boundary Z between the grooved portions 90X and 90Y but also in substantially the middle position of the grooved portion 90X.

In the grooved portion 90X in the second embodiment configured as above, any foreign matter moves rightward, while in the grooved portion 90Y any foreign matter moves leftward. Therefore, foreign matters can be shoved out more quickly and securely than where the bar 90 has only the spiral groove X or only the spiral groove Y, and seam flaws due to foreign matters can be restrained more effectively. Furthermore, since the web is cut along the boundary Z between the grooved portions 90X and 90Y in the second embodiment, any seam flaw occurring on the boundary Z can be removed by the time the web is fabricated into a finished product. Therefore, high-quality processed webs free from seam flaws can be manufactured.

Although the spiral groove X is disposed in an approximately ⅔ part of the bar 90 to the right and the grooved portion 90Y in which the spiral groove Y is disposed in an approximately ⅓ part of the bar 90 to the left in the second embodiment described above, conversely the spiral groove X may as well be disposed in an approximately ⅓ part of the bar 90 to the right and the spiral groove Y may as well be disposed in an approximately ⅔ part of the bar 90 to the left.

Further, though two grooved portions 90X and 90Y are provided in the axial direction of the bar 90 in the second embodiment described above, three grooved portions may be disposed as well. For instance, as shown in FIG. 9, a grooved portion 92Y having a spiral groove Y may be formed in an approximately ⅓ part of the bar 92 to the right, a grooved portion 92X having a spiral groove X in an approximately ⅓ part in the middle, and another grooved portion 92Y having another spiral groove Y in the remaining approximately ⅓ part to the left. In this case too, by cutting the web along the two boundaries Z and Z between the grooved portion 92X on one hand and the grooved portions 92Y and 92Y on the other, a product free from seam flaws can be fabricated. Incidentally in this case, each of the three grooves may have a pitch and a depth differing from the others.

Further, though the wider web 12 is supposed to be cut in two positions in the widthwise direction in the second embodiment described above, it may as well be cut in three or more positions. In this case, too, by matching the cutting positions with the boundaries Z between the grooved portions, a product free from seam flaws can be fabricated.

What is claimed is:

1. A web processing device comprising:
a coating unit which coats a long strip of web by using a bar having in an axial direction at least two spiral grooved portions differing in the spiraling direction of the spiral groove; and
a cutting unit which cuts the coated web in the lengthwise direction in a coating position along the boundary between the two spiral grooved portions.

2. The web processing device according to claim 1, wherein the coating unit is provided with a coating position adjusting device which adjusts a coating position in a widthwise direction of the web by shifting in the bar or the web relative to the widthwise direction of the web.

3. The web processing device according to claim 1, wherein the cutting unit is provided with a cutting position adjusting device which adjusts a cutting position in the widthwise direction of the web according to the coating position in the widthwise direction of the web in the coating unit.

4. The web processing device according to claim 1, wherein the boundary between the spiral grooved portions is so formed as not to let the spiral grooves overlap each other.

5. The web processing device according to claim 1, wherein the boundary between the spiral grooved portions is so formed as to overlap each other on the boundary between the grooved portions and the length of the overlapping part is kept not less than 10 mm but not more than 30 mm in the axial direction of the bar.

6. The web processing device according to claim 1, wherein the bar is formed by joining together rods at the end face in which spiral grooves differing in spiraling direction are cut.

7. The web processing device according to claim 2, wherein the cutting unit is provided with a cutting position adjusting device which adjusts a cutting position in the widthwise direction of the web according to the coating position in the widthwise direction of the web in the coating unit.

8. The web processing device according to claim 2, wherein the boundary between the spiral grooved portions is so formed as not to let the spiral grooves overlap each other.

9. The web processing device according to claim 2, wherein the boundary between the spiral grooved portions is so formed as to overlap each other on the boundary between the grooved portions and the length of the overlapping part is kept not less than 10 mm but not more than 30 mm in the axial direction of the bar.

10. The web processing device according to claim 2, wherein the bar is formed by joining together rods at the end face in which spiral grooves differing in spiraling direction are cut.

11. The web processing device according to claim 3, wherein the boundary between the spiral grooved portions is so formed as not to let the spiral grooves overlap each other.

12. The web processing device according to claim 3, wherein the boundary between the spiral grooved portions is so formed as to overlap each other on the boundary between the grooved portions and the length of the overlapping part is kept not less than 10 mm but not more than 30 mm in the axial direction of the bar.

13. The web processing device according to claim 3, wherein the bar is formed by joining together rods at the end face in which spiral grooves differing in spiraling direction are cut.

14. The web processing device according to claim 7, wherein the boundary between the spiral grooved portions is so formed as not to let the spiral grooves overlap each other.

15. The web processing device according to claim 7, wherein the boundary between the spiral grooved portions is so formed as to overlap each other on the boundary between the grooved portions and the length of the overlapping part is kept not less than 10 mm but not more than 30 mm in the axial direction of the bar.

16. The web processing device according to claim 7, wherein the bar is formed by joining together rods at the end face in which spiral grooves differing in spiraling direction are cut.
